(19) United States
(12) Patent Application Publication
(10) Pub. No.: US 2017/0024424 A1
(43) Pub. Date: Jan. 26, 2017

(54) Suggestive search engine

(71) Applicant: Saad Almohizea, Riyadh (SA)

(72) Inventor: Saad Almohizea, Riyadh (SA)

(21) Appl. No.: 14/809,234

(22) Filed: Jul. 26, 2015

(51) Int. Cl. G06F 17/30; G06F 3/0488; G06F 3/0482; G06F 3/0484; G06F 17/22; G06F 3/0481

(52) U.S. Cl. CPC G06F 17/30327; G06F 17/30554; G06F 17/30398; G06F 17/2235; G06F 3/04817; G06F 3/0482; G06F 3/04842; G06F 3/0488

(57) ABSTRACT

A search engine autocomplete user interface is disclosed, which provides auto-complete suggestions in both text and iconic form in order to save space and to provide a more intuitive layout. Autocomplete suggestions could be nested in a tree structure that could be navigated through using forward and back interfaces, and autocomplete suggestions could include both sub-searches within a specific domain or using other search engines, and could include functional cross tasks such as saving an event to a calendar.

### FIELD OF THE INVENTION

The field of the invention is online search engines

### BACKGROUND

Providing search results that a searching entity would find useful and/or appreciate is becoming both easier and more difficult. In some sense, searching has become easier since there exist many different search engines with different algorithms that can provide a variety of different types of searches on a variety of uniquely organized database systems. In another way, searching has become more difficult since the world contains a seemingly endless list of documents spread over hundreds of thousands of computers throughout the world. In order to find a document, an entity must frequently use different kinds of search engines using different queries. Systems that allow a user to integrate a plurality of search engines through a single portal have been created to improve the ability for an entity to find a useful result.

US2008/0071771 to Venkataraman teaches a search engine that organizes content items as an arrangement of conceptual clusters and subclusters that facilitate a search. When a user types a search item into a search box, several nearby clusters of the search item are displayed, and when a user navigates to a nearby cluster, subclusters of that cluster could then be displayed. Venkataraman, however, only provides search results in a text-based format, which is rather limited when considering that many types of media beyond text are available through computer devices. Venkataraman's system also repeats the suggestions over and over and doesn't provide a solution to providing many suggestions in a limited space.

US20140082550 to Farmer teaches a system that receives query input and then displays both suggested query terms and representative images for search results that match the query input. A text display window displays a list of text objects that correspond to the search term, and an image display window displays a list of image objects, such as a bank website or a news website, that corresponds to the search term. Farmer's system, however, is time consuming and is not dynamic.

U.S. Pat. No. 8,943,038 to Fein teaches a system and method for an integrated cross-platform multimedia broadband search, that returns a series of icons to display search results, where each icon can be linked to any number of different types of multimedia. Fein's icons could be linked to print media, cinema, shopping websites, streaming media, downloadable media, an application, or even a radio broadcast. Fein's system, however, only provides the icons in an unorganized grid pattern, which does not provide an intuitive organization structure that allows a user to understand how close a search result is to the search term.

Thus, there remains a need for a system and method that improves the way a user searches for a search result.

### SUMMARY OF THE INVENTION

The inventive subject matter provides apparatus, systems, and methods in which a computer system is configured to provide search information to a user interface.

It should be noted that any language directed to a computer system should be read to include any suitable combination of computing devices, including servers, interfaces, systems, databases, agents, peers, engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The computer system is generally configured with a user interface module that communicates content to and from a user interface, and a search engine module that performs searches on one or more informational database systems. Here, the user interface module is generally configured to present an interface to a user that allows the user to enter a search term, for example through a keyboard or a speaker. The user interface then generally passes the search term to the search engine which searches for various items related to the search term. Preferably, the user interface sends the search term to the search engine in real-time (for example, sending a current version of the search term to the search engine module every 0.1 seconds) while the user is typing the search term, so that the search engine can provide suggested search terms to the user while the user is still typing the search term, and to continuously refine the search while the search term is being typed.

The search engine module then generally runs a search on the current version of the search term and generates a list of suggested queries. Such suggested queries are generally pulled from a repository of query suggestions, and are pattern-matched against the search term. The search engine also generally runs a search for each of the suggested queries to find matches for each suggested query.

The matches for each suggested query could be varied. For example, some matches could be simple blocks of information, such as a summary describing the suggested query. Other matches could be links to other data repositories, such as a hyperlink to an article or a search result from another search engine or even links to previously visited websites. Matches could also comprise functions, such as an email or a phone call to be made to a phone number associated with the suggested query, or an event to be exported to a calendar application associated with the suggested query.

The search engine module also generally compiles the query suggestions and matches to the query suggestions into a search result tree having a plurality of levels. The root, or central node, of the search result tree is generally connected to the first level of nodes, each of which is connected to the second level of nodes, and so on. In a simple tree, the first level of nodes comprises the suggested queries, and the second level of nodes comprises matches to the suggested queries. The search engine module preferably pairs down the tree to remove duplicate information or duplicate matches. In a preferred embodiment, the search engine module might even remove duplicate information from different levels, such as where a match shares a similarity to a suggested queries, or from the same level, such as where a suggested query shares a similarity between another suggested query. An optimized system might be configured to pare down a search result tree to eliminate any similarities between any two nodes in the tree. As used herein, a “similarity” is an index between 0 to 100 that indicates how similar a portion of a match is to a portion of a suggested query. In some embodiments, the search engine module might only remove a duplicate suggested query if the similarity is over a threshold level, such as 70, 80, or 90.

Once the search result tree has been constructed by the search engine module, the search result tree is generally then sent to the user interface module to present the search result tree to the user interface. Each level of search results is generally presented in a different manner (such as in a different media format and/or a different direction) than the other levels of search results. For example, the suggested queries could be presented in text format in a vertically oriented list while the matches could be presented in an image or video format in a horizontally oriented list. The images/icons of the matches could represent specific hyperlink types, such as images, videos, or text blocks, or could represent specific identities associated with a hyperlink, such as a link to a Wikipedia® article or a link to an IMDB® entry.

In some embodiments, the matches are only presented by the user interface module when a user triggers the matches to be shown. For example, a user could click a button next to a suggested query to show the matches that match the suggested query, or a user could move a mouse pointer over a suggested query to show the matches for that suggested query.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a hardware schematic of a system of the present invention

FIG. 2 shows an exemplary autocomplete suggestion user interface.

FIG. 3 shows an improved autocomplete suggestion user interface having grouped icons.

FIG. 4 shows another improved autocomplete suggestion user interface.

FIG. 5 shows an improved autocomplete suggestion user interface having alternative configurations.

FIG. 6 shows an improved autocomplete suggestion user interface having mixed search and task icons.

FIG. 7 shows an improved autocomplete suggestion user interface having hidden icons.

FIG. 8 shows an improved autocomplete suggestion user interface having watermarked icons.

FIG. 9 shows an improved autocomplete suggestion user interface having offset watermarked icons.

FIG. 10 shows an improved settings user interface having watermarked icons.

FIG. 11 shows an improved autocomplete suggestion user interface having only icons.

FIG. 12 shows an improved autocomplete suggestion user interface having forward and back buttons to navigate a nested search tree.

FIG. 13 shows an improved autocomplete suggestion user interface having suggestions, icons, and a nested list.

### DETAILED DESCRIPTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. As used herein, the words “functionally coupled to” refer to two devices that are functionally coupled to one another through a network such that one device communicates with another device

Unless the context dictates the contrary, all ranges set forth herein should be interpreted as being inclusive of their endpoints, and open-ended ranges should be interpreted to include commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

One should appreciate that the disclosed techniques provide many advantageous technical effects including the ability to consolidate a plurality of related autocomplete suggestions using a combination of text, icons, and multiple axis to convey a large amount of data with a small amount of space.

The inventive subject matter provides apparatus, systems, and methods in which a computer system is configured to provide search information to a user interface.

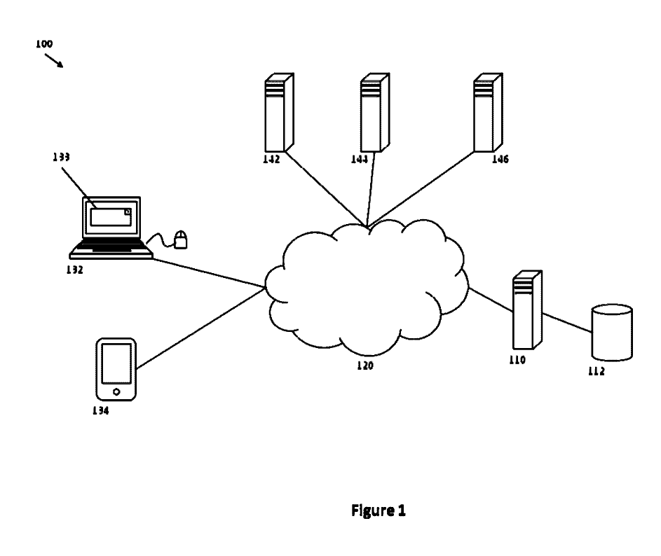

In FIG. 1, an exemplary search engine system 100 has a search computer system 110 coupled to a network 120, through which terminals 132 and 134 can communicate with search computer system 110 to perform searches, and through which search computer system 110 can access alternative computer systems 142, 144, and 146.

Network 120 is shown as a cloud of data, and could comprise any wired, wireless, or combination network that allows two electronic devices to communicate with one another, such as a cellular network, a local area network (LAN), a wide area network (WAN), a medium area network, an intranet, the Internet, or a combination thereof for functionally coupling any number of terminals, local computer systems, remote computer systems, and servers. Typically network 120 is the Internet, which allows a plurality of electronic computer devices to communicate information from one computer device to another computer device coupled to the Internet. Search computer system 110 is shown euphemistically as a single computer system having a processor and a memory having computer instructions that, when executed by the processor, perform functions such as provide connections to user interfaces for users to input search terms. Search database 112 is shown euphemistically as a single database functionally coupled to search computer system 110 that houses search repository data However search computer system 110 and search database 112 could be any number of computer systems and/or databases networked together, such as a plurality of computer systems coupled together in one or more blade servers and/or a plurality of RAID or NAS devices networked together. Exemplary search computer systems include a web server, an application server, a proxy server, a network server, or a group of computing devices in a server farm. Search computer system 110 typically provides a search engine user interface connection, such as a web server connection or a mobile device application connection, that allows remote access devices, such as terminal 132 or terminal 134, to connect to the search engine user interface connection and request data from search computer system 110. Database 112 could store any type of data accessible by search computer system 110. Such data could include web page data or content corresponding to one or more web pages.

Each terminal 132 and 134 preferably communicates with search computer system 110 over network 120. Terminal 132 is shown as a laptop computer with a mouse and keyboard and terminal 134 is shown as a touch-screen portable device, but any computer device having a user interface could be used, for example a tablet, a desktop computer, a hand-held computer, a desktop terminal, a personal digital assistant (PDA), a cellular telephone, a network appliance, a camera, a smart phone, an enhanced general packet radio service (EGPRS) mobile phone, a media player, a navigation device, an email device, a game console, or a combination of any these data processing devices or other data processing devices, having user interface hardware such as keyboards, mice, display screens, touch screens, microphones, speakers, or accelerometers. Preferably, a terminal has at least one processor, local memory, display, and one or more input/output devices. Terminal 132 or terminal 134 communicates with search computer system 110 through network 120, which provides a terminal connected to search computer system 110 with a user interface through which the terminal can enter search requests. In some embodiments, a terminal could be configured to communicate with search computer system 110 via a virtual private network (VPN), Secure Shell (SSH) tunnel, or other secure network connection. In some aspects, network 120 could further include a corporate network (e.g., an intranet) and one or more wireless access points.

As a user enters search requests into the user interface, search computer system 110 could perform a partial search on the entered information to provide autocomplete suggestions (i.e. query suggestions) according to embodiments of the current invention, and/or could perform a search on a fully complete, submitted search query. Autocomplete suggestions could also be seen as search results themselves, being search results found as a function of the partially entered query term. The means for search computer system 110 to provide such query suggestions could also include searching a repository of query suggestions accessible by search computer system 110, such as through a local repository or accessible through one of alternative computer system 142, 144, and 146. Search computer system 100 has an autocomplete function, which can suggest a list of most likely query suggestions in response to the currently typed-in portion of a search query by the user. These likely query suggestions can come from the repository of query suggestions stored in the search computer system or some other means. In some embodiments, search computer system 110 uses other search engines, such as those search engines provided by alternative computer systems 142, 144, and 146, to provide at least a portion of the autocomplete solutions. In some embodiments, search computer system 110 provides links to other search engines provided by alternative compute systems 142, 144, and 146. Such other search engines could be any known search engine using any known input mechanism, for example IMDB®, Wikipedia®, Google® Images, Yahoo®, or Bing®. While only three alternative computer systems 142, 144, and 146 are shown, more or less alternative computer systems could be accessed by search computer system 110 without departing from the scope of the current invention.

Contemplated terminals execute a client to connect to computer system 110, such as a browser 133. A terminal could be configured to execute different implementations of a client, where each implementation is targeted towards a different computing platform associated with a respective client device or towards a different client application. In some embodiments, client software could be a browser that requests web pages served by search computer system 110. In some embodiments, search computer system 110 could be associated with a third-party publisher or a provider or web content using one or more browser-supported programming languages, such as HTML, VB script, JavaScript, or another OS agnostic programming language. For example, terminal 132 could communicate with search computer system 110 to retrieve web page data or other content to be loaded into a browser 133. Browser 133 requests one or more web pages from search computer system 110 via network 120 using one or more communication protocols, for example HTTP. Search computer system 110 could then return a web page in response to such a request, which is then decoded by browser 133 to provide a user interface through which a user could input search queries. Input search queries could be input into terminal 132 with a variety of different devices, for example a keyboard, mouse, track pad, remote control, touchpad, touchscreen, a microphone, and/or a camera.

Embodiments of the present invention relate to search engine utilities. In particular, in response to a received user query, suggestions are typically provided to the user. This will be referred to as an auto-complete suggestion. After entering a word or a part of the word in the search field, the search engine dynamically predicts the best suggestion in real-time (typically fractions of a second) and suggests possible completed queries as a function of the entered characters in the search field. The system could be configured to update the suggestions each time the user adds or deletes a character. One advantage of such functionality is the ability to correct misspellings, which are commonly encountered.

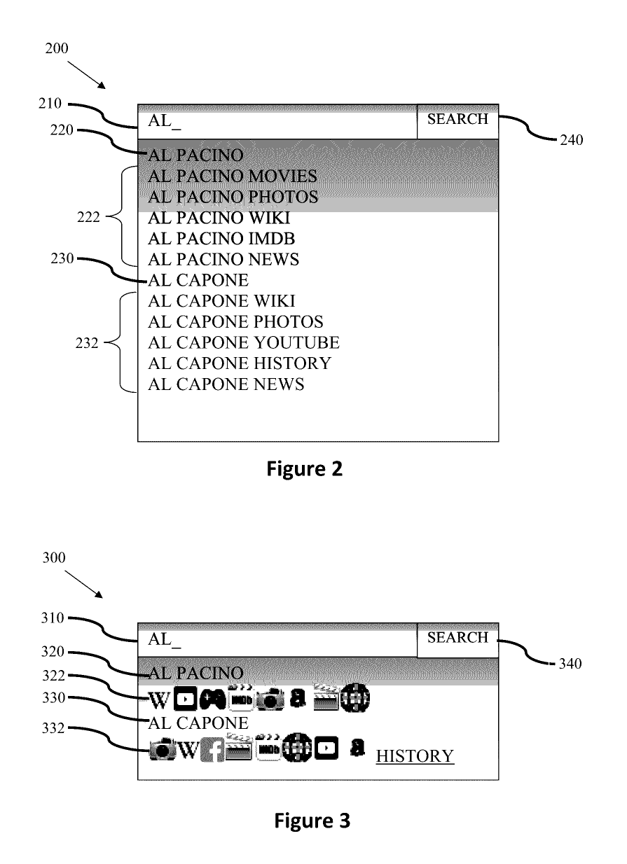

The list containing the suggestions is called a suggestion list. The list is preferably presented in text format but can be also in a visual format such as icons, images or other formats. FIG. 2 shows a typical user interface 200 having a suggestion list in response to a query 210 of “AL” with suggestion list including a suggestion 220 of “AL PACINO” among others. The suggestions are presented as a drop down menu but other variations, such as being grouped sideways with the suggestions listed next to each other in the same row, could also be used. Generally, a search engine constructs a first level of suggestion nodes having main suggestions, such as suggestion 220 of AL PACINO and suggestion 230 of AL CAPONE, and a second level of suggestion nodes under each node of the first level, such as suggestions 222 of various specific sub-topics under suggestion 220 and suggestions 323 of various specific sub-topics under suggestion 230. The most important suggestions are typically presented first, which are the suggestions most likely to be the top hit. That is, the suggestions with the highest relevance to the query 210 that has been typed so far are presented based on relevance, as discussed in further detail below.

The user then chooses between the suggestions shown in user interface 200 (by clicking on or otherwise selecting one of the suggestions) or his query (by, for example, activating the search button 240), and the search is launched after clicking on the screen, or touching the touchscreen depending on the device used. Other user interfaces, such as a stylus, a mouse, or a microphone with audio-recognition software could also be used.

The process by which the search engine fetches suggestions for the query can rely on stored data and certain algorithms. Such algorithms could take into account many criteria such as phonetic variation and, misspellings. The challenge remains to search large indices or popular query lists in under a few milliseconds so that the user sees results pop up while the user is inputting a suggestion. The computer system algorithms could rely on criteria like popular searches, geographic location, browsing history and trending top searches.

For the purpose of this disclosure, an auxiliary search engine refers to any search engine other than the default general search engine. An auxiliary search engine includes a default search engine with settings different from the default settings of the default search engine that would change the search results. It is generally a search with a narrower scope than a general search. Such auxiliary search engine focuses the results and limits distraction. For example a default engine could be a www.google.com® general search whereas an auxiliary search engine can be an image, video, shopping or game search available through Google® or other search engines. Auxiliary searches also include searches done within certain domains (e.g., only searches within the domain “aol.com”), websites or time frames, for example a Wikipedia® only search. Auxiliary searches also include searching for specific file types such as Microsoft® Word, MP3, or PDF documents with the option of downloading, listening or viewing such files from the World Wide Web.

As used herein, an “auxiliary item” represents auxiliary search engines in the suggestion list. The auxiliary item can be shown as a small icon or logo that is most representative of that auxiliary search engine for space efficiency. Other similar known representations, such as a thumbnail image, an animation and/or a text format representation could also be used. Such auxiliary items are associated with one or more suggestions to help focus the search. When an auxiliary item is selected, the corresponding auxiliary search engine could then be launched searching for a search term. For example, if the word “AL CAPONE” has an auxiliary item of an IMDB® icon, a user clicking on the icon could trigger a search for the words “AL CAPONE” using the IMDB® search engine. In other embodiments, selection of the auxiliary item could trigger a website search result, where the system automatically selects the highest ranked (usually the topmost) search result, similar to the “I'm feeling lucky” button on the Google® search engine. It is also possible that the ranking is determined as a function of the user's metadata, such as the user's geographic location or selection history.

As explained in the last example, auxiliary items could also represent direct webpages (i.e., instead of taking the user to a page with search results, selecting such auxiliary item would take the user directly to a webpage), deep links (site links, links within website) and cross-tasks for an application or app that links the web data to the computer or mobile device as will be explained in detail, later. Searches done through auxiliary search engines could be performed, for example, by embedding the query string into a search engine URL. Here, the search engine provides suggestions 220 and 230, each with a group of related auxiliary items, 222 and 232, respectively.

In some embodiments, auxiliary items, could be represented by, an image, news, video or a Wikipedia® icon. For example, in FIG. 3, user interface 300 shows a search 310 for the partial word “AL” having a suggestion 320 for “AL PACINO” followed by a row of auxiliary items 322, and a suggestion 330 for “AL CAPONE” followed by a row of auxiliary items 332. Preferably, each auxiliary item is tailored to each suggestion, with selected auxiliary items more appropriately linked to specific suggestions. When clicking an auxiliary item such as a Wikipedia® icon (shown as the first icon in list 322) the icon represents an auxiliary search engine within the Wikipedia® domain. When such an icon is clicked, a vertical search (a narrow scope search) is preferably launched and a search engine results page (SERP) could then be shown. The search result tree structure is easier to see in user interface 300, where the first level of search results for AL is shown as suggestion 320 for AL PACINO and 330 for AL CAPONE and the second level of search results for suggestion 320 AL PACINO is shown as the icons 322 for various sub-suggestions or auxiliary items (e.g. a Wikipedia® page or an IMDB® page for AL PACINO) and for suggestion 330 AL CAPONE is shown as the icons 332 for various sub-suggestions (e.g. a Facebook® site and Amazon® link for AL CAPONE).

General searches results could vary greatly in content and breadth. Search results can be improved by providing more inputs in the query box, which further limits the scope of search. In some embodiments, users may realize the search query is inadequate after the SERP is displayed, at which point the user changes the search query to receive another SERP. In many searches, this is discovered only in hindsight, when the user discovers that the entered query is not good enough or produces unrelated autocomplete suggestions and decides to rewrite or add to his query, which could consume user time. Another way to further limit the scope of the search is to provide more information as to where to look and not just what to look for. This is done by providing alternatives for the user to choose from in addition to providing search results of autocomplete suggestions. Such alternative searches could have narrower search scopes. Since the user typically must click search button 340 before any search is executed (by, for example, hitting the enter button corresponding to a general search) providing additional options representing specific domain searches in the form of auxiliary items, would not constitute an extra step, and the user need not to refine the original search since it has already been searched within a specific domain.

Auxiliary items can be displayed in several possible ways. In order to facilitate recognizing auxiliary items, their location in relation to the suggestions list is preferably repeated in the same pattern. This reduces user fatigue and distraction that occurs if the search results were arranged differently each time a user enters a different query. For example listing the auxiliary items adjacent to each suggestion would mean that for any given suggestion, there are many possible combinations that can result in different searches. For example as shown in user interface 300, inputting the query “AL” followed by a space character in the search box 310 could yield the following suggestions: “AL PACINO” 320, and “AL CAPONE” 330 among others. Adjacent to (in this case under) the suggestion “AL PACINO”, the auxiliary items 322 can be one or more of the following: image, IMDB®, Wikipedia®, movies, or news searches. The same is true for the suggestion 330 of “AL CAPONE” with an additional “HISTORY” auxiliary item represented textually in suggestions 332. Other contemplated suggestions (not shown) preferably each have their own auxiliary items, different from auxiliary items for other autocomplete suggestions. Combining suggestions with auxiliary items varies the scope of searches and at the same time focuses the chosen search to a specific domain representing the suggestion searched within the domain of that particular auxiliary item. It also means that other suggestions would not be needed especially when they are related to an auxiliary item in the same list. For example, if one of the subsequent suggestions were a link to the “Al Pacino” Wikipedia® page (http://en.wikipedia.org/wiki/Al_Pacino), such a link would not be necessary because a user would simply select the Wikipedia® logo (the stylized W) linked to the suggestion “AL PACINO” of auxiliary items 322. In addition, if the system were to provide a plurality of suggestions that are linked to the same page, (e.g. 3 links called “Al Pacino Wikipedia page” “Al Pacino Wikipedia” and “Al Pacino Wiki” that share a similarity) the system could remove the duplicate links, and replace one of the links with an icon for the Wikipedia® logo. Such similarities are preferably detected using a module that reviews similarities between suggested items, such as how similar a suggested item is (e.g. the alphanumeric string “Al Pacino Wikipedia Page” is very similar to the alphanumeric string “Al Pacino Wikipedia”), how similar a suggested link is (e.g. two suggestions may lead to the same site) or how similar a search results page might be (e.g. the search results for “Al Pacino movies” would be very similar to the search results for “Al Pacino films”). In a simple embodiment, such similarities would be compared on a character-by-character basis, but in more advanced embodiments the similarities could be weighted (e.g. similar characters would be weighted higher than similar spacing, and similar unique words would be weighted higher than similar commonly-repeated words).

Referring to user interface 200 as compared to user interface 300, linking suggestions to auxiliary items would save space considerably as discussed above since many suggestions are related to and/or overlapping with auxiliary items. In the example of “AL PACINO” in user interface 300, the mentioned auxiliary items could shorten the list of text suggestions, therefore there is no need to list “Al Pacino photos” or “Al Pacino movies” both of which occupy a considerable amount of space and include repetitions of the phrase “Al Pacino”, whereas an auxiliary item symbolized as an icon does not occupy much space and can still be interpreted correctly by the user when located next to the textual suggestion. The space needed is considerably smaller in user interface 300 as compared to user interface 200 even though they are both showing suggestions for the same query. Moreover, the search could be configured to result in a direct vertical search with a narrow scope search, rather than going to a general search page SERP. Narrow scope searches generally have an additional limiter in the search scope, for example a search scope that requires not only images related to Al Capone, but also images found on websites that also contain the name “Al Capone.” For example, if one were to search for Al Capone photos only, all he or she has to do is click the camera icon 332 next to the suggestion “AL Capone” in FIG. 3, which takes the user directly to a page with Al Capone image results. However, if one clicks on the suggestion “Al Capone photos” 232 in FIG. 2 it would take him to a SERP with many results which can contain some photos of Al Capone but also could have links which are unrelated to the intended search and not just photos.

A homepage auxiliary item is an auxiliary item, which directs the user to the official webpage of a suggestion, or the most likely one. For example the suggestion “Toyota” when linked with a homepage auxiliary item, the search engine would search for the most likely homepage and instantly load that homepage bypassing a search SERP page, in this example the following link: http://www.toyota.com. Such an auxiliary item could be very similar to the “I'm feeling lucky” button featured on Google®. One way of fetching homepages is to add the suggestion to a .com link, while another way is to search for webpage described as the official homepage of that suggestion. The homepage icon could be designated by either a unified icon for homepage addresses or the icon or logo of that particular website. This is more easily recognized than a URL link. Generally, the homepage is listed on top of a search engine results page.

As described in the Toyota example, since the auxiliary search engines narrows the breadth of the results greatly to a particular area or dominion (the homepage of a particular suggestion) and therefore, in most cases it would be on the top of the list of results of that search, it would be desirable in one variation to skip the page of results of that auxiliary search engine and head directly to and load the top result, thus saving a considerable amount of time which is wasted otherwise on loading the results, curiously reading through the other results and finally deciding to go for the desired result. In such an embodiment, the icons of the auxiliary search engine could look the same but the computer system preferably automatically picks the best match for the query. For example in user interface 300, if one is to enter “AL” in the entry box 310, one of the automatically generated suggestions 320 would be “AL PACINO”. The user has the option of launching a general search for “AL” by clicking the search button 340, or by launching a specific search for “AL PACINO” by selecting the “AL PACINO” 320 link in the suggestion list, which are both examples of a general search. However if one is to click the “W” icon in auxiliary icon list 322, representing an auxiliary item of the Wikipedia® auxiliary search engine, and since it is linked to “AL PACINO” in this embodiment, not only does clicking the “W” icon perform the search but also loads the best result without going through the extra step of a search results page—in this case a Wikipedia® webpage about Al Pacino. Since these auxiliary items will encompass most domains related to a particular search suggestion the list might be viewed as a classic search result page, and these auxiliary items can be viewed to be direct URL links instead of search engines. In other embodiments, an auxiliary item might contain a link to a previously visited website.

In one embodiment, the direct loading of a website without displaying the SERP is to be done only if there is sufficient probability that the top web site is the perfect match, and below that threshold a general search is conducted instead. This is determined by relevant criteria such as location, prior searches and popular searches. Embodiments of the present invention are able to provide both narrowly targeted search and general searches.

One way of fetching suitable auxiliary items for a particular suggestion could be to go through a classic general search of that suggestion, review the top results, classify and categorize the results based on what they represent, and cancel repetitions before ranking the results. For example if a search for the query “England” is performed, a classic general search could yield top results including the following: map of England and a link to England in the Wikipedia® domain among others. Ranking of suitable auxiliary search engines could then be performed based on the general search results, and a map search and a Wikipedia® search icons could appear adjacent to the suggestion of “England”.

Certain auxiliary search engines can be stored in a source data and linked to common queries. Queries could also be grouped under common categories, for example the “AL PACINO” query is under the entertainment group which is linked to auxiliary search engines such as, IMDB®, Wikipedia®, movies, images among others. Therefore, after categorizing a particular query, certain auxiliary search engines are linked and suggested to that query and ranked according to geographic location, browsing history, language preferences, trending searches among other criteria.

In order to find an appropriate representation of auxiliary items in the form of icons or logos, a “web crawler” program, which searches the Internet dynamically to find icons or logos for auxiliary items that do not have associated icons, could be used.

Providing icons is far more efficient because they are readily discernible by the user. Rather than a web page link or a small thumbnail image of what the webpage looks like, the user could instantly tell what the logo signifies. It also standardizes web browsing by predicting in advance what the user is looking for and leading him directly to it.

It is preferred that suggestions are not repeated in relation to other suggestions. This could happen when suggestions are gathered from multiple sources. These similar suggestions preferably do not stem from the same root of word but still mean the same. For example, the word movies and films mean roughly the same thing and are preferably not repeated as a suggested item. Another form of repetition that is avoided is one that overlaps with the suggested auxiliary search engines. For example if one is to search for “Al Pacino,” one of the suggested auxiliary search engines could be an image search, and therefore the suggestion (Al Pacino photos) should not appear in the suggestion list. This algorithm assures that different suggestions of a wider breadth can be attained.

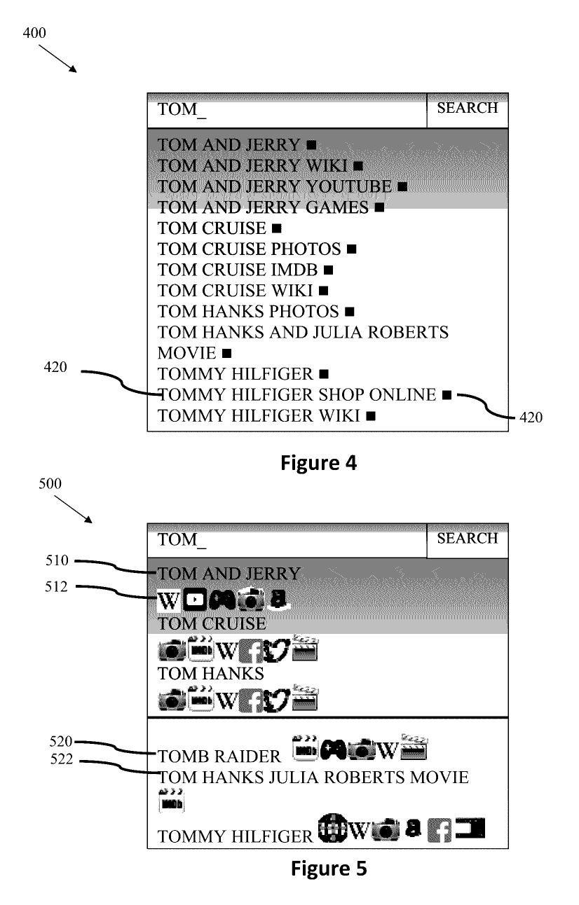

Different embodiments are described on how to arrange the auxiliary items relative to the suggestions especially in the setting of a touch screen device with its known space limitations. These arrangements are described for auxiliary items whether they are configured to show a search results page SERP or go directly to URL link. In FIG. 4, to actively engage the user into the two types of search, without having to go to change settings, a black squared icon 420 is provided next to each suggestion. If the user clicks the suggestion 420 (Tommy Hilfiger Shop Online) a search is done within that particular theme, displaying a search engine results page However, if the user chooses to select the black icon 420 next to that suggestion (Tommy Hilfiger Shop Online) the search is performed and the most likely perfect hit is loaded without going through a SERP. Accordingly, an official Tommy Hilfiger online shop is displayed instantly to the user. This gives the user the flexibility in deciding on how to execute the search depending on his query and the suggestion and the likelihood that the he is close to what he is looking for. Likewise, in another embodiment, clicking the auxiliary item once could trigger a search within that domain while clicking it twice triggers that search and chooses the best result, and automatically loads that webpage without displaying a search results page.

FIG. 5, the auxiliary items 512 in user interface 500 are right below its related suggestion 510. Although a full row enables the addition of many items for each suggestion, this considerably consumes space reducing the number of total suggestions. In another example, the auxiliary items are arranged right next to the suggestion on the same row 520. The drawback here is that some suggestions are made of more than one word or have long words with only a limited space for auxiliary items to be added as shown in suggestion 522 “Tom hanks Julia Roberts movie”

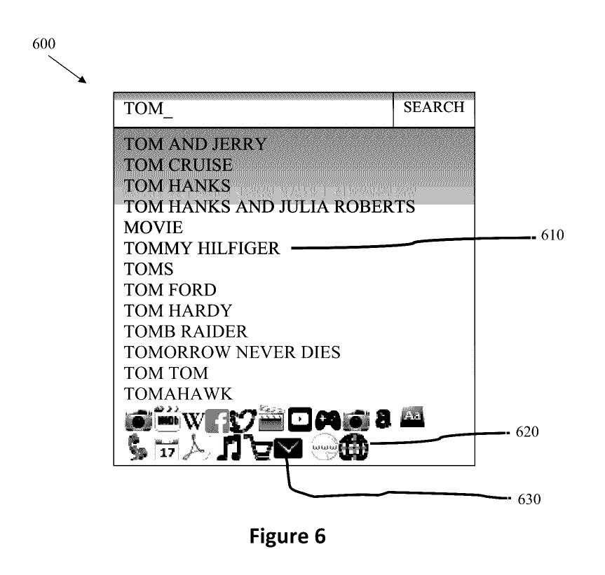

In another embodiment the auxiliary items are located only at one end of the screen (preferable the lower end) as shown in FIG. 6. One or more rows should encompass the most common auxiliary items such as image, video news searches etc. unlike other variations, the auxiliary items here are fixed since they are related to all suggestions and only the most common vertical searches are presented. When one decides on which suggestion and in what field or theme he wants to perform his search, he chooses the most appropriate auxiliary item, drops down the auxiliary item into its designated suggestion by pressing and moving the icon to the suggestion without lifting his finger until he reaches the row that contains the suggestion. Since the auxiliary items for common theme search need only be presented once, suggestions (tom cruise photos, tom hanks photos, tom hardy photos tom cruise movies, tom hanks movies, tom hardy movies etc.) need not be presented and only the name of the actor is presented once and the auxiliary items each presented once. This is space efficient and is only possible in such arrangements and with an algorithm that accounts for it and cancels repetitions.

Referring to FIG. 6, in user interface 600, a user wishes to go directly to the official homepage of tommy Hilfiger in the shortest way. If she clicks on the “Tommy Hilfiger” word 610 in the suggestion list a SERP is generated representing a general type of search. The world like icon 620 represents homepage search, and when clicked it searches for the homepage of a particular query, chooses the most likely hit, and launches the webpage bypassing a SERP. To associate the auxiliary item 620 with tommy Hilfiger 610 the user has to press on the icon 610, keep pressing and drop it to the suggestion (tommy Hilfiger). This is interpreted as a direct loading of the homepage and www.tommyhilfiger.com URL link is displayed. One way of insuring that the correct most relevant homepage (or official website) is fetched, is by searching URL links containing the same query, which is typical for most homepages links.

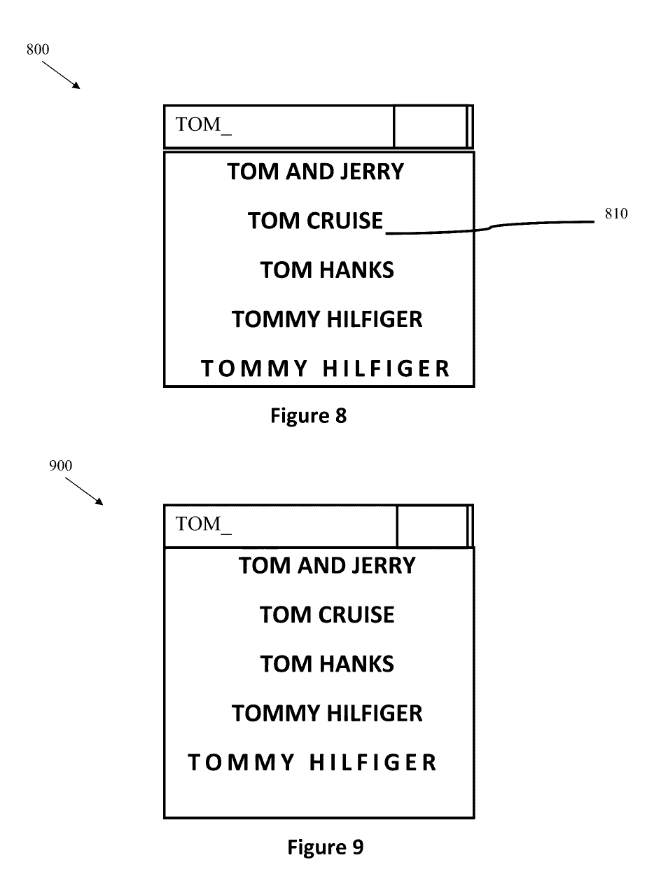

In another embodiment, as shown in FIG. 8, user interface 800 has the auxiliary items that are arranged within the same row (or space allocated for the suggestion) along with its suggestion 810. This is done by changing the graphic parameters of either the suggestion or the auxiliary items. Modifying parameters like size, Color, transparency, sharpness, gradient fill and degree of saturation can enable one to discern the suggestion (tom cruise in this example) from the background of auxiliary items (the Q icon) 810, even if they overlap. For example having the auxiliary items in a light grayish color superimposed by a smaller darker textural suggestion located at the middle of the row would be easy to read and recognize both the suggestion and icons. Such arrangement is space saving and recruits many auxiliary items for each suggestion. It also provides assurance to the user when clicking on an auxiliary item by giving the feeling and assurance that he is clicking and searching for the suggestion linked to the auxiliary item. In other words, the suggested items are in normal print and the auxiliary items are in a watermark print. As used herein, a “watermark” is a graphical representation having a higher amount of transparency than other displayed print. Here, the words TOM CRUISE have a lower amount of transparency than the icons, which have a higher amount of transparency than the words TOM CRUISE. In other variation of this embodiment, as shown in user interface 800, the spacing of letters of the suggestion is increased to more than 0.3 pt and less than 5 pt. This widens the gap between words and facilitates in recognizing the icons. In another variation the icons of the auxiliary items retain their original color but with a lower saturation (less than 90% or original saturation). Since we associate certain icons with certain colors (for example blue for the Facebook® icon) this might aid in recognizing different icons. In non-touch screens, if one is to hover a cursor around an icon it can be configured to be at full saturation to make it more visible.

In another variation of the last embodiment and if the auxiliary items are configured to be constant for all suggestion, applying the most common themes of search such as image, video, Wikipedia® etc. searches, and since the location of the icons would be on the same column for any given suggestion it would also possible to expand the icon over the entire column or part of it and/or with repetitions as shown in user interface 900 shown in FIG. 9. Therefore the icon could be expanded to its full textural theme and can be repeated. In this variation it is easier to appreciate and discern icons since even if they are obscured by a longer suggestion it can be more visible in other locations such as between two rows of suggestions.

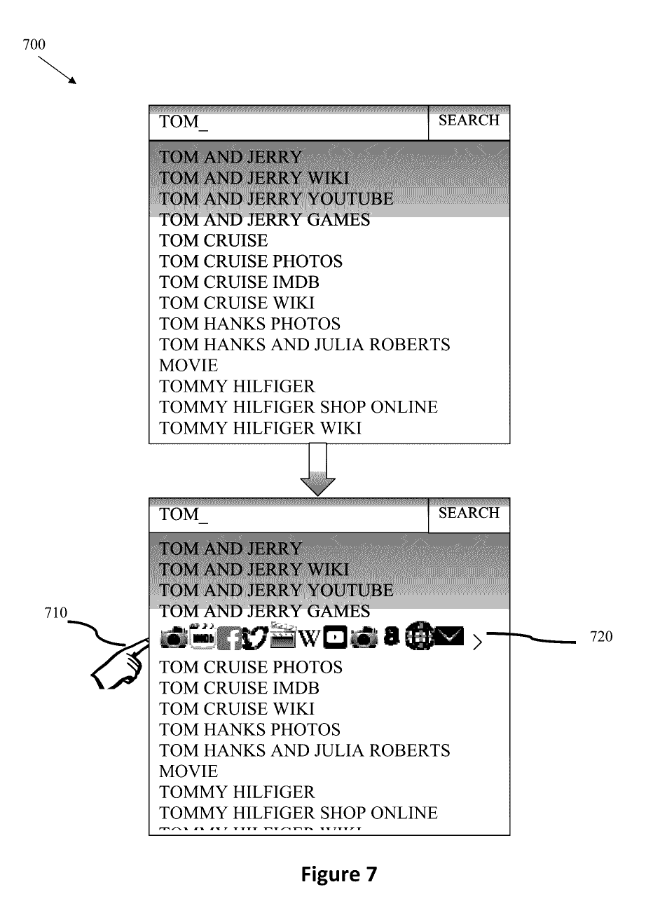

In another user interface 700 as shown in FIG. 7, and in devices that employ technologies of touchless gesturing such as floating Touch® in Xperia and Airview® in Samsung, where special screens are designed to sense an approaching finger and highlights links or displays text in a response, only when at a predetermined distance from the screen. Applying these technologies in the context of auto-complete suggestion lists where the auxiliary items are only shown when the approaching finger is close to one suggestion 710 (tom cruise in this example) either in a pop up box or within the suggestion or even replacing the suggestion row with auxiliary item as shown in FIG. 7 alternatively both the suggestion and the auxiliary items can be shown overlapped at the same row similar to what's is shown in FIG. 8 when the finger is approaching the screen. The auxiliary items can be configured to show more (with a higher saturation) as the finger is approaching. The same can also be done if one is to hover a cursor over the suggestion, with the auxiliary items replacing the suggestion or present in the background and/or only colored when the cursor is there. The distance could be varied according to the screen size but in most cases a distance of about 1 to 3 cm is ideal. The same touchless technology can be used also to further highlight the auxiliary items in FIGS. 8 and 9.

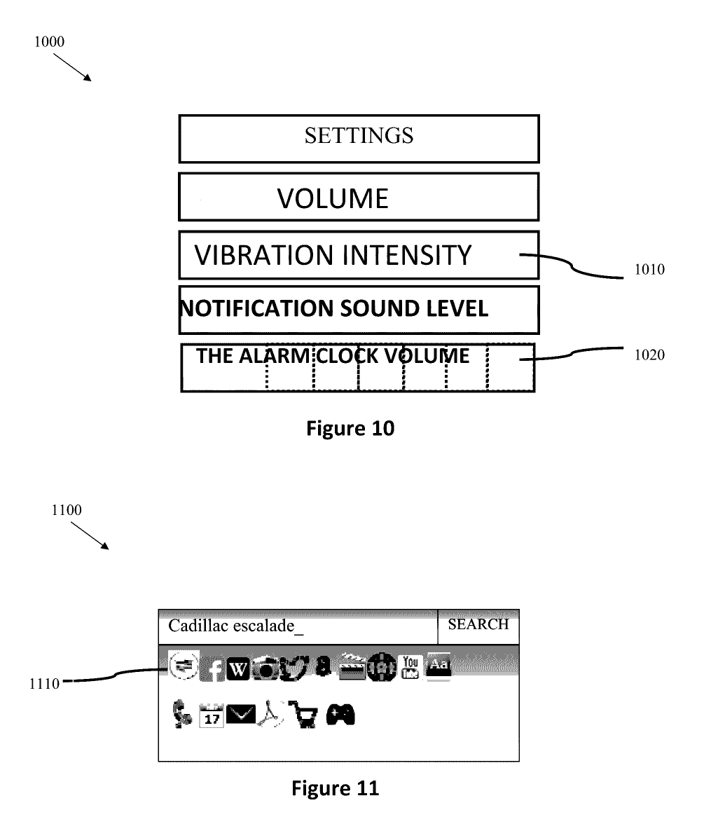

Although the overlapping of two different but related categories (suggestion and auxiliary items) can be accomplished as described in FIGS. 8 and 9, the same concept can be applied in any lists or menu especially in a smart phone device. A stem menu item such as volume is related to submenu items such as numbers from 1 to 7, representing the level of volume. This is explained in FIG. 10, where a submenu can be shown within the row of its stem menu and overlapping with it. This is possible by changing parameters such as size, Color, transparency, sharpness, gradient fill and degree of saturation. For example if one is to click on number 2 on second row (vibration intensity 1010) the user might have chosen a level 2 of intensity and so forth. This negates the need for displaying another screen to choose a particular intensity from, which is also true for all other settings in user interface 1000. This is especially useful when the submenu options are limited to a few or when they are ordered such as with numbers, which makes it easier for the user to predict where a specific item of the submenu will be located. The techniques of touch-less gesturing described above can facilitate the way the elements of submenu are chosen. For example they can be configured to only appear when the approaching finger reaches a certain distance, or have it gradually appear more visibly as the finger is closing the distance and even replacing the original stem menu with the submenu elements.

In yet another variation of an embodiment, and as shown in user interface 1000, the elements of the submenu are much smaller and located just below the textural suggestion 1020. Each element however is contained within a larger square. The margins of this square could be invisible, lined or dotted. In this variation even though the elements are smaller than the elements of vibration intensity 1010 it is not overlapping with the suggestion making it easier to recognize. But clicking anywhere in the containing square would still function just the same if one clicks on the icon itself. In other words the whole square containing that particular icon is set as a trigger point that, when activated in a user interface, activates functionality associated with the icon For example, if a user activates the number 5 in the ALARM CLOCK VOLUME box by selecting it on a touch screen or clicking the number 5 with a mouse, the system could set the volume of the alarm clock to 5. This can be done also with auxiliary item, represented by small icons below its designated suggestion.

It is understood that other variation in accessing screens whether it is a desktop or a mobile device screen can be implemented. In certain suggestion or when an extensive list of auxiliary items are to be shown and due to space limitations, additional auxiliary items can be recruited by an arrow 720 as shown in FIG. 7 which when clicked would either unfold the icons as a submenu within the same suggestion list page or opens in another page. Similarly another way of recruiting more icons is by swiping the icons bar. For example the auxiliary items can be swiped to reveal other icons without leaving the page or moving the textural suggestion.

Such arrangements are more crucial in mobile devices and small screens where a specialized arrangement is necessary to include as a many auxiliary items as possible without clutter and in a way that makes use of the full potential of the screen.

In another embodiment the auxiliary item represents cross tasks. For the purpose of this disclosure a cross task is a function present in a software or an application in the device, such as calling a phone number, emailing a particular person or adding an even to the calendar, which is made accessible within a suggestion list in the autocomplete function or the search results page SERP. These cross tasks anticipates the users intent, and execute the intended function without having to manually launch the parent software or application. These cross tasks are related to suggestions and are can be presented the same way as auxiliary items are. An example is where the auto-complete function has generated a list of suggestions some of which are restaurants. Right next to the suggestion “pizza hut” an icon for calling a phone number is provided. If the user is to click a phone icon representing a cross task, the phone is searched for and the number is dialed. This saves time that would be otherwise lost in copying the number, quitting the current screen, looking for the call application in the phone, pasting the number in the correct box and dialing. This can be also done to any task in the phone. Another example in shown in FIG. 6, where the envelope icon 630 is representing a cross task for emailing a particular person. If one is to associate the envelop icon with Tommy Hilfiger, the email of that person (or company) is searched for, the best match is chosen, the email application in the phone is launched, and the mail is pasted in a new email to be written by the user. Examples of such common tasks include but are not limited to adding dates or events shown in the search results to the calendar application, using the dictionary to know the meaning of words, sharing a URL link, a song or a video with social media provider or an email account, downloading certain files, texting, using icloud and emailing.

Certain suggestions are recognized to be associated with certain common tasks within the device, much like associating auxiliary search engine with certain suggestion as described before. For example a phone number is recognized when it starts with common codes, or they are 7 digits long or when preceded by the word “tel”. Dates are always associated with calendars and places with a map application.

In a variation of the above, if more than one hit is found for an attempted cross task, such as more than one email, the top hits (emails) are presented to the user to choose from. In short one can call a company just by clicking a call icon cross task associated with the name of the company in the suggestion list without having to manually search it and manually call the phone.

In another embodiment as shown in FIG. 11, in user interface 1100 the user could enter a query in the search box (Cadillac escalade), the auto-complete function delivers the suggestion list, but this time the top hits are presented as icons, without textual items. These icons or logos are the best representation of the websites hosting that particular web page in the search results; in this example searching for Cadillac escalade would generate icons of the Cadillac car company and, Wikipedia® icons among others. These are direct URL links and not links to searching. This is feasibly since people can readily associate results with visual indicators faster than reading textural representation. In such embodiment the suggestion list can be populated by only the type of icons mentioned above, be part of it with textural suggestions listed later. In other words for some queries with clear intent in mind, presenting icons, logos or any visual representation such as a thumbnail image of websites is sufficient, and clicking on them would take the user directly to a desired web page. In such scenario the icons don't necessarily represent the homepage but instead a subpage within that website that is most related to the entered query. In the example above, even though a Cadillac logo 1110 is presented in the search results, clicking on it will not load the homepage of the Cadillac car company but would go directly to a Cadillac escalade webpage. Likewise clicking on the Wikipedia® icon will not load the homepage of the Wikipedia® website but instead would load a subpage for Cadillac indexed by Wikipedia®. the process by which the search results are linked to certain icons are any one of those known in the field. for example web crawlers can search and store such icons in a data source for future use.

In another embodiment as shown in figures, links or hyperlinks to an entire website, part of a website or a webpage or part of a webpage is indexed, summarized and presented under the auto-complete function and listed in the suggestion list. The auto-complete function provides the option of having suggestions extracted, gathered, and arranged from specific websites, which are highly associated with the entered query. Optionally such functionality could be only activated at the request of the user by adding a specific link or arrow that activates extraction for a particular suggestion. Preferably such extraction is done for websites that are the official homepages of the entered query when one exists, such as the homepage of Toyota® Car Company “www.toyota.com”. Such extraction is preferably done when the likelihood that the query matches a homepage that such process is activated. Extraction recruits hyperlinks or links within that website and subpages. However, titles, listings, headings, subheadings and navigation bar components within these websites can be included especially when they contain secondary hyperlinks under them. This enables the user to navigate the main components of a website, in the auto-complete function, reach his target without having to download unnecessary pages to reach his match.

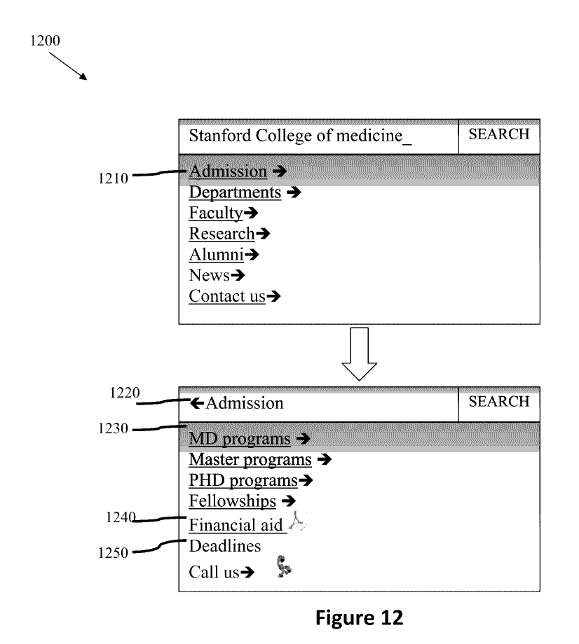

In FIG. 12 the user enters the query “Stanford college of medicine” the auto-complete function associates that with the homepage of that college and provides hyperlinks for that webpage as part of the suggestion list. For example the suggestions “admission” 1210, is present among others. Clicking one of these suggestions would take the user directly to the URL link of that webpage (the Admissions webpage under the Stanford College of Medicine homepage) instead of loading first the homepage (the Stanford College of Medicine homepage), looking for the desired link, which is harder in the midst of graphics, ads, and other links, and then selecting the link of the Admissions webpage. Advertisements and nonessential webpage components can considerably lengthen the time to load a webpage. Furthermore, the inconsistency of arranging important and certain hyperlinks, like the contact address, makes it harder to find them quickly, with some of them on the top and in some websites at the right or even at the bottom of the page in others.

In order to streamline the process, the search engine could search a homepage, gather webpage links from that homepage, and show those webpage links as search results, such as search result (or suggestion) 1210 “admission”. It is also possible to have sub-links of chosen hyperlinks (or secondary links linked to primary links) where one can navigate through the whole website, find his match instantly and load that particular page, all within the suggestion list of the auto-complete function. For example if one clicks the arrow next to admission 1210 (instead of admission which takes him to the hyperlink for admission webpage), the admission webpage is extracted and another suggestion list displays the following links “MD programs” 1230, “Deadlines” 1250 among others which are links that are contained in the admission webpage. The user can go back and forth within the website until he finds his match. This is convenient for those users who have visited the page before and know exactly what they are looking for and want to go directly to it. Note that in this example only suggestions, which are underlined, are hyperlinked while others are not. Clicking a suggestion that is not hyperlinked such as 1250, would load the web page that contains that suggestion and preferably with that part of the page displayed first on top (scrolled to it).

In user interface 1200, where suggestions have been extracted from the homepage website of Stanford college of medicine. An arrow to the right of the suggestion indicates that there are certain hyperlinks, headings or titles contained within the webpage of that suggestion. An underlining means that the suggestion is hyperlinked to a different webpage. If a suggestion is not underlined such as “deadlines” 1250, this means that this suggestion is contained within the webpage of the suggestion in the entry box “admission” 1220 and represents a component of that webpage but it not itself a link. If the user wants to return back to a previous page he can click the arrow on the left of the “admission” which takes him to the previous page. Therefore the user can switch back and forth, navigate through pages and links without having to load the web page. Only when the suggestion and the arrows are clicked that a specific webpage is displayed. Optionally, if a webpage contains certain file types, such as word, PDF or music documents, these can be extracted too and added in the suggestion list. The “financial aid” 1240, suggestion is actually a file and is followed by a PDF icon, when clicked it either displays or downloads the file without having to load the whole webpage that contains that PDF file.

These hyperlinks and headings can populate the entire suggestion list. In such list the autocomplete aggregates suggestions only from the most related web site to the query. Alternatively, they may form part of the suggestion list where the rest of the list is propagated through processes known in the technical field. Preferably, algorithms should account for these hyperlinks and cancel repetitions that might arise with other suggestions. They can also linked to auxiliary items just like in the previous embodiments. To distinguish these suggestions, which are extracted from certain web sites, they can be in a different font, color or size or even grouped in a separate group.

The hierarchy of these hyperlinks can be arranged in more than one way. For example each suggestion has an arrow that unfolds into secondary hyperlinks that are present within the web page of the primary hyperlink or listed beneath it in the same web page (or opens in another page). In another variation all hyperlinks of the website can be included in one page scrollable or resized to include all. Depending on how big is the website and how many hyperlinks are present the choice is made.

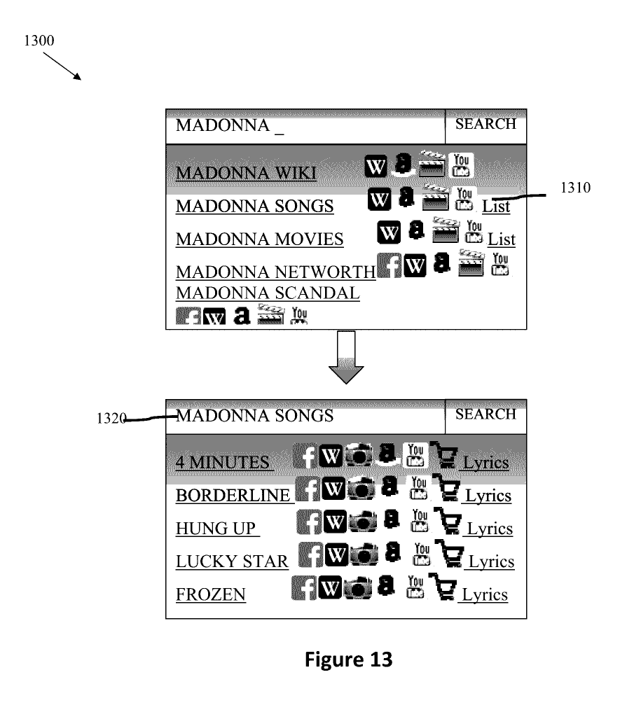

The location for extraction for can be based on many criteria. As mentioned above in most occasions, the homepage of that query would be a rich source for extracting relevant suggestions. This can be accomplished for example by adding to the query the term “homepage”. However in other occasions such homepages don't exist, and other webpages should be searched for. For example searching for famous people, entertainment, countries and historical events, the Wikipedia® website would be a rich source. In another variation the URL link that is closest to the entered query is extracted. For example in FIG. 13, in user interface 1300 for the suggested query “Madonna songs” 1310, a websites URL link containing that entry is appropriately extracted and it would show a long list of songs by the artist to navigate through, a list that is exceedingly hard to come by in conventional auto-complete suggestion lists and conventional algorithms. Alternatively, a Wikipedia® subpage for Madonna songs is extracted. The user then can decide what song to choose and whether he wants to download, listen, shop, or watch a YouTube® video by clicking on the auxiliary item next to the chosen suggestion.

Here, the system has identified MADONNA SONGS and MADONNA MOVIES as categories. As used herein, a “category” is a search result that contains a keyword that is designated as a category by an administrator. Contemplated categories include songs, movies, menu items, and store items. Here, the search result “MADONNA SONGS” has a category keyword “songs” and the search result “MADONNA MOVIES” has a category keyword “movies.” Typically, the system will associate sub-search results under each category in a search result tree, where a first level of search results will have MADONNA SONGS and MADONNA MOVIES as nodes and the second level of search results will have songs made with Madonna as nodes under the MADONNA SONGS node and movies made with Madonna under the MADONNA MOVIES node. The user interface displays the word “List” 1310 as a category trigger, and when a user selects the category trigger, the user interface displays contents of the category, along with auxiliary items, such as a Youtube® video link and lyrics (for a song).

In a variation the ranking of these deep links are done to reflect best popular links first or make them in a bigger font or in a different color. It can also be underlined, italicized, or in any other way presented such that they stand out relative to other suggestions. In another variation order is done in way that simulate the websites original look as much as possible. The same can also be done for auxiliary items with bigger icons indicating those with a higher ranking

Another variation of the last embodiment as shown in FIG. 13 is done for listing data branching from a particular suggestion, by automatically adding the entry “list” to the query. A specialized icon can be used for such search. For example if the user wants to list the songs by Madonna in the auto-complete list, he writes Madonna songs and hits the icon for listing or the link “list” 1310. “List” represents an auxiliary item; it can be present either next to the suggestion or the query. The search engine searches the web for a website or a webpage that lists the songs, extracts the text and present in the suggestions list. This might be a URL link that is closest to the entered query. The user then can choose his favorite song and decide what to do next by choosing the appropriate auxiliary item (listening, buying, downloading etc.). Alternatively the search engine can extract from the most likely homepage related to “Madonna” which will be a Wikipedia® webpage and will extract the songs and list it in the suggestion list. The same can be done for lists of movies by an actor, awards by a singer, shows by a TV channel, indications for a drug, restaurants in a location, items sold by a merchant, cars manufactured by a company, matches and scores for a sports club and so forth.

The process by which the search engine can extract these suggestions from a webpage can be done in more than one way. For example the search engine can scan the source code of the webpage for hyperlinks, navigation bar components and titles of the whole website, arrange them accordingly and present it as suggestions in the auto-complete list. Arranging these suggestion can simulate the look of the original websites as much as possible but takes into account the ranking and importance of such links. For example common hyperlinks such as “contact us” are appropriately located at the end of the list. Another way of extracting metadata is to examine the sitemap (if accessible) portion of the website and repeat the same steps as above. One of The most important web pages to extract in a website is the index page. Depending on the web server settings, this index page can have many different names, but the most common is index.html.

Another way can be performed when Web search engines work by storing data about many web pages, which they retrieve from the page's HTML. A web crawler retrieves these pages. It works by automatically following every link on the site and detecting changes. By doing so the search engine can effectively retrieve links from stored data without having to load that particular page.

Another related technique for accessing web pages from the Internet is referred to as web clipping. Specifically, the web clipping technique involves installing a web clipping application on a personal digital assistant or a smart phone for each web page that its user desires to receive information from. Typically, when activated, a web clipping application transmits a request to an Internet server for limited web content (commonly referred to as web clipping) from a specific web page. It is appreciated that a web clipping is compressed HTML (Hypertext Markup Language) page, which is transmitted by the Internet server to the requesting personal digital assistant.

As is well known to one skilled in the art, rendering means to process a document for representation. For example, an HTML document includes data and format instructions (i.e., tags). The format instructions need to be rendered before it can be displayed in its intended way. Rendering is typically done with a web browser. The rendering engine of the web browser essentially processes format instructions and converts them into graphical elements, determines the layout and calculates the overall appearance of the document.

Extraction can also be done with a text-based web browser that renders only the text of web page, including hyperlinks and ignores graphic content. Examples of such browsers include lynx and textise browsers. These browsers can be tweaked to renders only parts of the text, namely titles, headings, navigation bar items and hyperlinks, as described above

The techniques described in the last embodiment allows for a safer navigation to suspicious websites, since the user doesn't have to download graphics or JavaScript that might be malicious. The user, after navigating through a website within the auto-complete function can decide that he doesn't need to visit the website and opt for another search further undermining any potential threats.

In a variation the auto-complete function is the only platform available for the search engine without a classic search engine results page SERP. This is more appropriate for small screens where a full URL links with descriptions is not necessary, and in such scenario the results can be pulled down to reveal more results or shown in a second page. This relieves the user from having to go to another page or platform to view results, which can be already shown in the auto-complete list.

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

As will be understood, the “selection” of an item viewed in any one of the figures can be accomplished by any way known in the art depending on the device used such as touching a smart screen in a mobile device, clicking a mouse button in a desktop device or pressing the enter key in a keyboard of a laptop device

It is understood that although this disclosure is intended primarily for autocomplete function, some aspects of the invention can be implemented in classic search. For example the arrangement of icons next to the suggestions can also be done in SERP, with icons located next to search results, which also reduces repetition and increases space efficiency if this is to be accounted for in the search algorithms. Displaying icons of known websites reduces the time needed to read through SERP. Likewise, icons of cross tasks can be displayed next each results as described above.

It is also understood that although suggestion lists of the autocomplete function can be displayed in many ways. Most commonly, a drop down menu variety has been used extensively and has been used in the figures. However other variations like suggestions lists that goes up from a search box located at the bottom of the screen, or when the suggestions are listed next to each other or grouped are other possible alternatives.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

Input from the use and feedback to him can be utilized by any known way in the field. This can include the user can input to the computer can be used as well. Other kinds of interaction known in the field can be used too for example, feedback provided to the user can be in the form of sensory, visual, auditory, or tactile or even speech interaction.

It should be apparent to those skilled in the art that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . And N, the text should be interpreted as requiring only one element from the group, not A plus N, or B plus N, etc.

What is claimed is:

1. A non-transitory, computer-readable medium for providing information to a user interface, comprising instructions stored thereon, that when executed on a processor, perform the steps of:
Receiving a search term from a user interface;
Generating a first set of search results comprising suggested queries;
Generating a second set of search results comprising matches for each of the suggested queries;
Generating a search result tree having a first level of nodes comprising the first set of search results and a second level of nodes comprising the second set of search results; and
Presenting the search result tree to a user interface, wherein the first set of search results is presented in a first media format in a first direction and the second set of search results is presented in a second media format in a second direction.

2. The non-transitory, computer-readable medium of claim 1, wherein the first media format comprises a text format and the second media format comprises an image format.

3. The non-transitory, computer-readable medium of claim 2, wherein the image format comprises a set of icons, wherein each of the set of icons represents a different search engine.

4. The non-transitory, computer-readable medium of claim 1, wherein the first media format comprises a text format and the second media format comprises a video format.

5. The non-transitory, computer-readable medium of claim 1, wherein the first direction comprises a vertical direction and the second direction comprises a horizontal direction.

6. The non-transitory, computer-readable medium of claim 1, wherein the first set of search terms radiate from a centralized node comprising the search term.

7. The non-transitory, computer readable medium of claim 1, wherein the matches for each of the suggested queries comprise a set of hyperlinks associated with the suggested query.

8. The non-transitory, computer readable medium of claim 1, wherein the matches for each of the suggested queries comprise a set of functions associated with the suggested query.

9. The non-transitory, computer readable medium of claim 8, wherein at least one of the set of functions is configured to trigger a task by an application installed on the non-transitory, computer-readable medium associated with a suggested query of the first set of search results.

10. The non-transitory, computer readable medium of claim 9, wherein the task comprises at least one of the group consisting of calling a phone number, initiating an email to an email address, or adding an event to a calendar.

11. The non-transitory, computer readable medium of claim 1, wherein at least one of the second set of matches is configured to trigger a search for the suggested query using an auxiliary search engine and automatically select the highest-rated search result.

12. The non-transitory, computer readable medium of claim 1, wherein at least one of the suggested queries is configured to trigger a search and automatically select the highest-rated search result.

13. The non-transitory, computer readable medium of claim 1, wherein the instructions are further configured to perform the steps of:
Recognizing a similarity between a match from the second level of nodes and a suggested query from the first level of nodes and
Deleting the suggested query from the first level of nodes.

14. The non-transitory, computer readable medium of claim 1, wherein the instructions are further configured to perform the steps of:
Recognizing a similarity between a first match from the second level of nodes and a second match from the second level of nodes and
Deleting the second match from the second level of nodes.

15. The non transitory, computer readable medium of claim 13, wherein the instructions are configured to perform the step of deleting the suggested query from the first level of nodes when the recognized similarity exceeds a predefined threshold.

16. A non-transitory, computer-readable medium for providing information to a user interface, comprising instructions stored thereon, that when executed on a processor, perform the steps of:
Receiving a search term from a user interface;
Generating a set of search results based on the search term;
Matching each search result to an icon representative of the search result; and
Displaying each search result as an icon to the user.

17. The non-transitory, computer readable medium of claim 1, wherein the instructions are further configured to perform the step of presenting the search result tree to the user interface by presenting the search results as a watermark.

18. The non-transitory, computer readable medium of claim 17, wherein the instructions are further configured to perform the step of presenting the search result tree to the user interface by overlaying at least a portion of the second set of search results with at least a portion of the first set of search results.

19. The non-transitory, computer readable medium of claim 17, wherein the instructions are further configured to perform the step of presenting the search result tree to the user interface by displaying at least a portion of the second set of search results under at least a portion of the first set of search results.

20. The non-transitory, computer readable medium of claim 18, wherein the instructions are further configured to display the second set of search results differently from the first set of search results by varying at least one of the group consisting of size, Color, transparency, sharpness, gradient fill or degree of saturation.

21. The non-transitory, computer readable medium of claim 1, wherein the instructions are further configured to perform the step of presenting the search result tree to the user interface by presenting the second set of search results only when an approaching finger is at a predetermined distance from the screen or less.

22. The non-transitory, computer readable medium of claim 21, wherein the predetermined distance is between 1 and 3 cm.

23. The non-transitory, computer readable medium of claim 21, wherein the predetermined distance is calculated using a touchless gesture technology.

24. A non-transitory, computer-readable medium for providing information to a user interface, comprising instructions stored thereon, that when executed on a processor, perform the steps of:
Presenting a menu item to a user;
Linking the menu item to a plurality of submenu items; and
Executing the function of the menu item when a submenu item is selected, wherein the function is configured is to represent both the menu item and the submenu item by overlaying at least a portion of the menu item with at least a portion of the submenu items by the use of a watermark.

25. The non-transitory, computer readable medium of claim 24, wherein the instructions are further configured to perform the step of presenting the menu item to the user interface by presenting the submenu items only when an approaching finger is at a predetermined distance from the screen or less.

26. The non-transitory, computer readable medium of claim 25, wherein the predetermined distance is between 1 and 3 cm.

27. The non-transitory, computer readable medium of claim 25, wherein the predetermined distance is calculated using a touchless gesture technology.

28. A non-transitory, computer-readable medium for providing information to a user interface, comprising instructions stored thereon, that when executed on a processor, perform the steps of:
Receiving a search term from a user interface;
Matching the search term with a webpage;
Extracting one or more items from the webpage, wherein the item comprises at least one of the group consisting of: a hyperlink, a title, a heading, a subheading or a navigation bar item;
Indexing the items into a list of search results;
Presenting the list of search results to the user interface;
Enabling a user to select at least one item, of the search results; and
Loading the item when the user selects the item.

29. The non-transitory, computer-readable medium of claim 28, wherein the item is a hyperlink.

30. The non-transitory, computer-readable medium of claim 29, wherein the instructions further perform the steps of:
Extracting the hyperlink from the search results for a second item or more, wherein the second item comprises at least one of the group consisting of: a hyperlink, a title, a heading, a subheading or a navigation bar item;
Indexing the second items into a second list of search results;
Presenting the second list of search results to the user interface;
Enabling the user to select the second item, of the second search results; and
Loading the second item when the user selects the second item.
